(19) United States
(12) Patent Application Publication
(10) Pub. No.: US 2013/0235149 A1
(43) Pub. Date: Sep. 12, 2013

(54) IMAGE CAPTURING APPARATUS

(71) Applicants: Tomonori TANAKA, Kanagawa (JP); Noriyuki TERAO, Miyagi (JP); Yoshiaki IRINO, Kanagawa (JP); Toru HARADA, Kanagawa (JP); Hideaki YAMAMOTO, Kanagawa (JP); Hirokazu TAKENAKA, Kanagawa (JP); Satoshi SAWAGUCHI, Kanagawa (JP); Nozomi IMAE, Kanagawa (JP); Daisuke BESSHO, Kanagawa (JP); Kensuke MASUDA, Kanagawa (JP); Hiroyuki SATOH, Kanagawa (JP); Makoto SHOHARA, Tokyo (JP)

(72) Inventors: Tomonori TANAKA, Kanagawa (JP); Noriyuki TERAO, Miyagi (JP); Yoshiaki IRINO, Kanagawa (JP); Toru HARADA, Kanagawa (JP); Hideaki YAMAMOTO, Kanagawa (JP); Hirokazu TAKENAKA, Kanagawa (JP); Satoshi SAWAGUCHI, Kanagawa (JP); Nozomi IMAE, Kanagawa (JP); Daisuke BESSHO, Kanagawa (JP); Kensuke MASUDA, Kanagawa (JP); Hiroyuki SATOH, Kanagawa (JP); Makoto SHOHARA, Tokyo (JP)

(73) Assignee: Ricoh Company, Limited, Tokyo (JP)

(21) Appl. No.: 13/778,511

(22) Filed: Feb. 27, 2013

(30) Foreign Application Priority Data
Mar. 8, 2012 (JP) 2012-051521
Dec. 17, 2012 (JP) 2012-274183

(51) Int. Cl. H04N 5/232

(52) U.S. Cl. CPC H04N 5/23238
USPC 348/36

(57) ABSTRACT

An image capturing apparatus for capturing an image of a subject using a plurality of imaging devices and a plurality of lenses for the imaging devices, respectively, includes a plurality of buffer memories for the imaging devices, respectively, each buffer memory being configured to store image data output from the corresponding imaging device; and a single image processor configured to read the image data stored in the buffer memories in a time division manner and perform predetermined image processing on the image data.

### CROSS-REFERENCE TO RELATED APPLICATIONS

The present application claims priority to and incorporates by reference the entire contents of Japanese Patent Application No. 2012-051521 filed in Japan on Mar. 8, 2012 and Japanese Patent Application No. 2012-274183 filed in Japan on Dec. 17, 2012.

### BACKGROUND OF THE INVENTION

1. Field of the Invention

The present invention generally relates to an image capturing apparatus.

2. Description of the Related Art

There are conventionally known omnidirectional image capturing apparatuses that create a panoramic image or the like by capturing a plurality of images of a subject in an omnidirectional manner (i.e., in 360 degrees) with a plurality of lenses and a plurality of imaging devices (CCD sensors, CMOS sensors, or the like) and combining a plurality of image data sets acquired by the image capturing.

However, such a conventional omnidirectional image capturing apparatus includes as many image processing circuits as the imaging devices. Each of the image processing circuits is assigned to one of the imaging devices and performs necessary image processing such as black level correction, color interpolation, and correction of dropout pixels on image data acquired by image capturing using one of the lenses and one of the imaging devices that are assigned to the image processing circuit. Data handling becomes complicated because the plurality of image processing circuits handles image data sets output from the plurality of image devices separately in this way. Furthermore, a necessary amount of image processing hardware increases as the number of the imaging devices increases, which results in an increase in cost.

For instance, Japanese Patent Application Laid-open No. 2006-033810 discloses a multi-sensor panoramic network camera that includes a plurality of image sensors (imaging devices), a plurality of image processors (image processing circuits), an image postprocessor, and a network interface, in which the image processing circuits and the image sensors are equal in number.

Therefore, there is a need, concerning an image capturing apparatus such as an omnidirectional image capturing apparatus that uses a plurality of imaging devices, to simplify data handling that is complicated because a plurality of data sets are handled separately, and to increase reliability. There is also a need to avoid an increase in cost resulting from an increase in amount of image processing hardware resulting from an increase in the number of imaging devices.

### SUMMARY OF THE INVENTION

It is an object of the present invention to at least partially solve the problems in the conventional technology.

According to an embodiment, there is provided an image capturing apparatus for capturing an image of a subject using a plurality of imaging devices and a plurality of lenses for the imaging devices, respectively. The image capturing apparatus includes a plurality of buffer memories for the imaging devices, respectively, each buffer memory being configured to store image data output from the corresponding imaging device; and a single image processor configured to read the image data stored in the buffer memories in a time division manner and perform predetermined image processing on the image data.

According to another embodiment, there is provided an image capturing apparatus for capturing an image of a subject using a plurality of imaging devices and a plurality of lenses for the imaging devices, respectively. The image capturing apparatus includes a plurality of buffer memories for the imaging devices, respectively, each buffer memory being configured to store image data output from the corresponding imaging device; a synchronization detector configured to monitor synchronization of output timing for outputting image data from the imaging devices and control a timing of reading the image data from each buffer memory; a buffer-memory reading unit configured to read the image data stored in the buffer memories in a time division manner in response to the timing of reading the image data; and a single image processor configured to perform predetermined image processing on the image data read from the buffer memories in the time division manner.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram of an omnidirectional image capturing apparatus which is an example of an image capturing apparatus according to embodiments of the present invention;

FIG. 2 is an overall configuration diagram of a processing system of the omnidirectional image capturing apparatus according to the embodiments;

FIG. 3 is a detailed configuration diagram of an image processing unit according to a first embodiment;

FIG. 4 is a diagram illustrating how image data is transferred in the first embodiment;

FIG. 5 is a detailed configuration diagram of an image processing unit according to a second embodiment;

FIG. 6 is a diagram illustrating how image data is transferred in the second embodiment;

FIG. 7 is a diagram illustrating how image data is stored in buffer memories in the second embodiment;

FIG. 8 is a diagram illustrating a relationship between a data area on an image sensor in an imaging device and a fisheye-lens image area;

FIG. 9 is a diagram illustrating a specific example method for outputting image data from an imaging device; and

FIG. 10 is a diagram illustrating another specific example method for outputting image data from the imaging device.

### DETAILED DESCRIPTION OF THE PREFERRED EMBODIMENTS

Exemplary embodiments will be described below with reference to the accompanying drawings. In the embodiments, image capturing apparatuses are embodied as omnidirectional image capturing apparatuses that include two lenses (fisheye lenses) and two imaging devices. Generally, the number of the lenses and that of the imaging devices can be any number more than one; the image capturing apparatus is not necessarily embodied as an omnidirectional image capturing apparatus. It is generally desirable that the lenses are wide-angle lenses, ultrawide-angle lenses, or fisheye lenses each having an angle of view of 120 degrees or more. In the embodiment, fisheye lenses with an angle of view of 180 degrees or more are used.

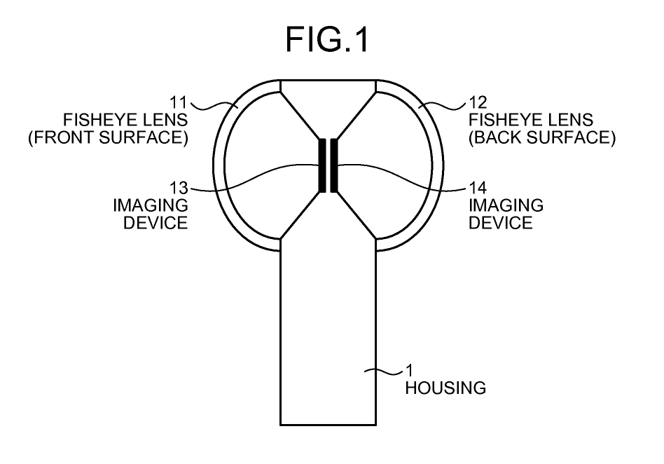

FIG. 1 is a schematic diagram of an omnidirectional image capturing apparatus according to an embodiment. The omnidirectional image capturing apparatus includes two fisheye lenses, which are fisheye lenses 11 and 12, each having an angle of view of 180 degrees or more for forming a hemispherical image, and two imaging devices, which are imaging devices 13 and 14, that are respectively arranged at positions where the hemispherical images are formed by the fisheye lenses 11 and 12. Meanwhile, the fisheye lenses 11 and 12 are arranged on a housing 1 with back surfaces of the fisheye lenses 11 and 12 facing each other to capture an image of a subject in an omnidirectional manner (i.e., in 360 degrees). The imaging devices 13 and 14 are housed in the housing 1.

Arranged on the housing 1 is an operation unit including various types of operation buttons, a power switch, and a shutter button. The housing 1 also internally includes, in addition to the imaging devices 13 and 14, circuit boards mounted on which are an image processing unit for processing image data output from the imaging devices 13 and 14, an imaging control unit for controlling operations of the imaging devices 13 and 14, a CPU for controlling operations of the entire image capturing apparatus, memories, and the like.

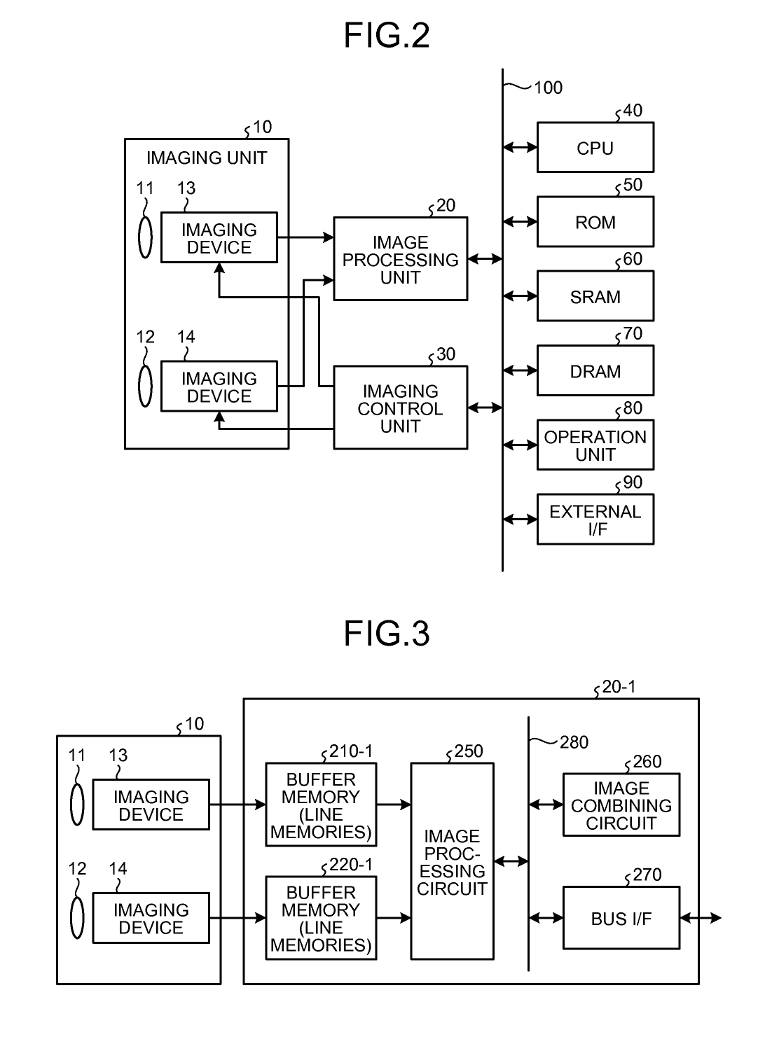

FIG. 2 is an overall configuration diagram of a processing system of the omnidirectional image capturing apparatus according to the embodiment. Referring to FIG. 2, it is assumed that the fisheye lenses 11 and 12 and the imaging devices 13 and 14 make up an imaging unit 10. Each of the imaging devices 13 and 14 includes an image sensor such as a CMOS sensor or a CCD sensor that converts an optical image captured through the fisheye lens 11, 12 into image data represented by electrical signals and outputs the image data, a timing generating circuit that generates horizontal/vertical sync signals and pixel clocks for the image sensor, and a register set to be loaded with various types of commands, parameters, and the like necessary for operations of the imaging device.

Each of the imaging devices 13 and 14 of the imaging unit 10 is connected to the image processing unit 20 via a parallel I/F bus. Each of the imaging devices 13 and 14 of the imaging unit 10 is connected to the imaging control unit 30 via a serial I/F bus (e.g., an I²C bus (registered trademark)). The image processing unit 20 and the imaging control unit 30 are connected to a CPU 40 via a bus 100. A ROM 50, an SRAM 60, a DRAM 70, the operation unit 80, an external I/F circuit 90, and the like are connected to the bus 100.

The image processing unit 20 generates spherical image data by acquiring image data sets output from the imaging devices 13 and 14 via the parallel I/F buses, performing predetermined processing on each of the image data sets, and combining these image data sets. The present invention particularly relates to the image processing unit 20. Two example embodiments, which will be described later, of the image processing unit 20 are conceivable.

The imaging control unit 30 generally loads the commands and the like, in which the imaging control unit 30 is assumed as a master device and the imaging devices 13 and 14 are assumed as slave devices, into the register sets of the imaging devices 13 and 14 via the I²C buses. The necessary commands and the like are fed from the CPU 40. The imaging control unit 30 also acquires status data and the like in the register sets of the imaging devices 13 and 14 via the I²C buses and transmits the status data and the like to the CPU 40. The imaging control unit 30 also instructs the imaging devices 13 and 14 to output image data at an instant when the shutter button of the operation unit 80 is pressed.

Some omnidirectional image capturing apparatuses have a function of displaying a preview on a display and an ability of supporting a motion video. The imaging devices 13 and 14 of such an omnidirectional image capturing apparatus output image data continuously at a predetermined frame rate (frames/min.).

The CPU 40 controls operations of the entire omnidirectional image capturing apparatus and performs necessary processing. The ROM 50 stores various types of program instructions for the CPU 40. The SRAM 60 and the DRAM 70, which are working memories, store program instructions for execution by the CPU 40, data in a course of being processed, and the like. The DRAM 70 is also utilized to store image data in a course of being processed by the image processing unit 20 and processed spherical image data.

The operation unit 80 collectively refers to a touch panel or the like that provides functions of displaying and for operating the various types of operation buttons, the power switch, and the shutter button. A user operates the operation buttons, thereby inputting various photographing modes, photographing conditions, and the like.

The external I/F circuit 90 collectively refers to interface circuits (a USB I/F and the like) to an external memory (an SD card, a flash memory, or the like), a personal computer, and the like. The external I/F circuit 90 can be a wired or wireless network interface. Spherical image data stored in the DRAM 70 is stored in an external memory via the external I/F circuit 90, or transferred to a personal computer, a smartphone, or the like via the external I/F circuit 90 which is a network I/F as required.

Specific configurations and operations of the two example embodiments of the image processing unit 20, which is a primary element of the present embodiment, are described below in detail.

FIG. 3 is a detailed configuration diagram of an image processing unit 20-1 according to a first embodiment of the. The image processing unit 20-1 includes a buffer memory 210-1 for the imaging device 13, a buffer memory 220-1 assigned to the imaging device 14, a single image processing circuit (image processor) 250, an image combining circuit 260, a bus I/F circuit 270, and an internal bus 280 that connects the image processing circuit 250, the image combining circuit 260, and the bus I/F circuit 270 to one another. The bus I/F circuit 270 is connected to the bus 100 illustrated in FIG. 2.

Each of the imaging devices 13 and 14 outputs horizontal/vertical sync signals, pixel clocks, and the like in conjunction with image data. These signals are supplied to the buffer memory 210-1, 220-1 and the image processing circuit 250.

The buffer memories 210-1 and 220-1 are line memories to and from which data writing and data reading are performed independently. Write clock and read clock of the buffer memories 210-1 and 220-1 differ from each other in frequency in such a manner that the frequency of the read clock is m (m≧2) times as high as or higher than the frequency of the write clock. When the frequency of the read clock is m times as high as the frequency of the write clock, image data is not overwritten before the image data is read out. It is possible to change the number of the line memories by changing the number of m.

Each of the buffer memories (line memories) 210-1 and 220-1 sequentially stores image data output from corresponding one of the imaging devices 13 and 14. The image processing circuit 250 reads out the image data stored in these buffer memories 210-1 and 220-1 alternately line by line or on a per-group-smaller-than-one-line basis in a time division manner. The image processing circuit 250 groups the image data read out from the buffer memory 210-1 and the image data read out from the buffer memory 220 in the time division manner and sequentially performs predetermined image processing on the grouped image data in real time. The image processing to be performed by the image processing circuit 250 can include black level correction, color correction, correction of dropout pixels, and white balance adjustment.

The grouped image data into which the image data from the imaging devices 13 and 14 are grouped and onto which image processing is performed by the image processing circuit 250 is transferred to the DRAM 70 via the bus I/F circuit 270. The grouped image data into which the image data from the imaging devices 13 and 14 are grouped and transferred to the DRAM 70 is separated into image data from the imaging device 13 and image data from the imaging device 14, and written into a storage area in the DRAM 70 for the imaging device 13 and a storage area for the imaging device 14, respectively.

Meanwhile, some image processing performed by the image processing circuit 250, such as lens distortion correction (correction of color aberration/distortion), cannot be performed on grouped image data into which image data from the imaging devices 13 and 14 are grouped. Such image processing can be performed as follows. When processed image data output from the imaging device 13 or 14 and corresponding to one screen is stored in the DRAM 70, the CPU 40 reads out the image data output from the imaging device 13 or 14 and corresponding to one screen, and transfers the image data to the image processing circuit 250. The CPU 40 sequentially repeats this process. The image processing circuit 250 performs predetermined image processing, such as lens distortion correction, on the image data output from the imaging device 13 or 14 and corresponding to one screen, and writes the image data to the DRAM 70 again. The image processing circuit 250 sequentially repeats this process.

The image combining circuit 260 acquires the image data output from the imaging device 13 and the image data output from the imaging device 14, on each of which the predetermined image processing is performed, from the DRAM 70 via the bus I/F circuit 270, and combines the image data. Stored in the DRAM 70 are two hemispherical image data sets each of which is acquired by image capturing by one of the imaging devices 13 and 14 and on which predetermined image processing is performed. As described above, because each of the two hemispherical image data sets represents an image captured with an angle of view 180 degrees or more, each of the images has an overlap area. The image combining circuit 260 generates spherical image data by combining the two hemispherical image data sets utilizing the overlap areas.

The spherical image data generated by the image combining circuit 260 is stored again in the DRAM 70 via the bus I/F circuit 270. Thereafter, the spherical image data is stored in an external memory via the external I/F circuit 90, or transferred to a personal computer or the like via the external I/F circuit 90 which is a network I/F as required.

Alternatively, there can be employed a configuration in which the image combining circuit 260 generates a Mercator image as the spherical image data, and the CPU 40 converts the Mercator image into an omnidirectional panoramic image (spherical panoramic image) by geometric conversion.

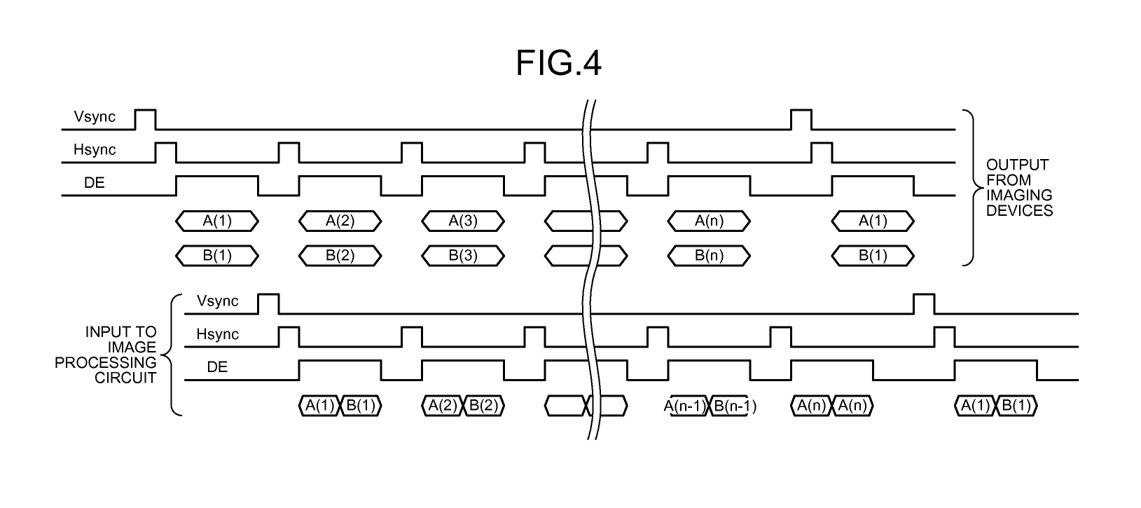

FIG. 4 is a diagram illustrating how image data is transferred in the first embodiment. Signals are plotted in FIG. 4 against time on the horizontal axis.

In FIG. 4, Vsync denotes a vertical sync signal that is output from the imaging devices 13 and 14 only once at a leading end of each page of a two-dimensional image. Hsync denotes a horizontal sync signal that is output from the imaging devices 13 and 14 at a leading end of each line of the each page. DE (data enable) denotes a data enable signal that is also output from the imaging devices 13 and 14. Each of A(1), A(2), A(3), . . . denotes image data for one line output from the imaging device 13. Each of B(1), B(2), B(3), . . . denotes image data for one line output from the imaging device 14. The imaging devices 13 and 14 also output pixel clocks.

The image data A(1), A(2), A(3), . . . output from the imaging device 13 is temporarily and sequentially stored in the buffer memory (line memories) 210-1. Similarly, the image data B(1), B(2), B(3), . . . output from the imaging device 14 is temporarily and sequentially stored in the buffer memory (line memories) 220-1. The image data A(1), B(1), A(2), B(2), A(3), B(3), . . . output from the imaging devices 13 and 14 is in synchronization.

The image processing circuit 250 reads out the image data stored in the buffer memories 210-1 and 220-1 alternately line by line in a time division manner. Specifically, the image processing circuit 250 reads out the image data A(1) from the buffer memory 210-1 first, and subsequently reads out the image data B(1) from the buffer memory 220-1. The image processing circuit 250 reads out the image data A(2) and B(2), A(3) and B(3), . . . from the buffer memories 210-1 and 220-1 in a similar manner. The image processing circuit 250 sequentially performs predetermined image processing on each group of the image data A(1) and B(1), A(2) and B(2), A(3) and B(3), . . . read out from these buffer memories 210-1 and 220-1 in real time and outputs the image data.

As described above, the write clock and the read clock of the buffer memories 210-1 and 220-1 are set in such a manner that the frequency of the read clock is m (m≧2) times as high as or higher than the frequency of the write clock. In this example, m is set to two. When m is set to two, line memories for approximately two lines can satisfactorily be used as each of the buffer memories 210-1 and 220-1. When such line memories are used, the image processing circuit 250 can read out image data A(i) and B(i) for the (i)st line stored in the buffer memories 210-1 and 220-1 before the image data A(i) and B(i) is overwritten by image data A(i+1) and B(i+1) for the next (i+1)st line (i=1, 2, . . . , n). When m is set to a value equal to or greater than three, line memories for less than two lines can be used as each of the buffer memories 210-1 and 220-1. In other words, line memories for up to two lines can satisfactorily be used as each of the buffer memories 210-1 and 220-1.

According to the first embodiment, the single image processing circuit processes image data from a plurality of (in the first embodiment, two) imaging devices as a single image data set. Accordingly, the need of having as many image processing circuits as the imaging devices is eliminated, and the amount of hardware of the image processing circuit can be reduced. Although as many buffer memories as the imaging devices are required, buffer memories are simpler in configuration than image processing circuits. Furthermore, line memories for up to two lines can satisfactorily be used by virtue of the relationship between the frequency of the read clock and the frequency of the write clock. Accordingly, an increase in cost can be reduced as compared with a configuration in which the number of image processing circuits increases as the number of imaging devices increases.

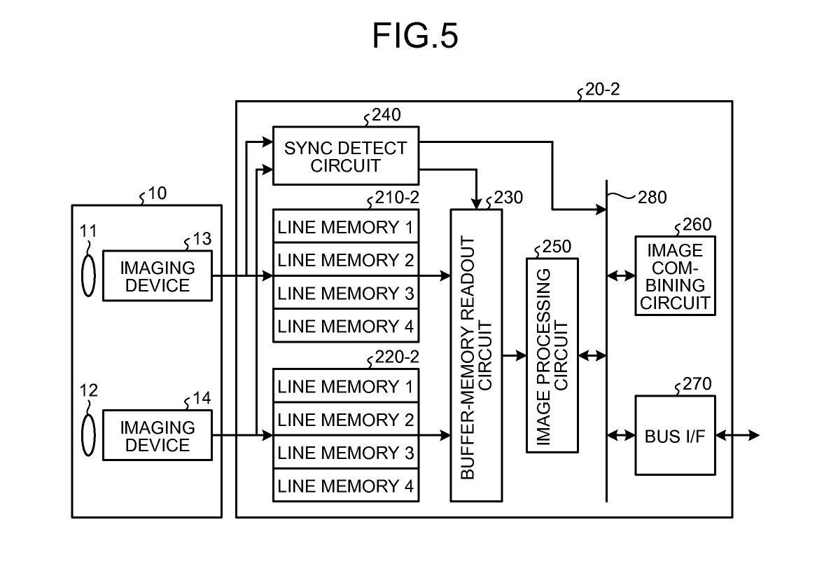

FIG. 5 is a detailed configuration diagram of an image processing unit 20-2 according to a second embodiment. In the first embodiment, when output timing for outputting image data from the imaging devices 13 and 14 is out of synchronization, the image processing circuit 250 fails to properly read out the image data for the same line, which is output from the imaging devices 13 and 14, from the buffer memories (line memories) 210-1 and 220-1. The second embodiment allows the image processing circuit 250 to acquire the image data for the same line, which is output from the imaging devices 13 and 14, even when output timing for outputting image data from the imaging devices 13 and 14 is out of synchronization by a certain degree.

Referring to FIG. 5, the image processing unit 20-2 includes the buffer memory 210-2 assigned to the imaging device 13, the buffer memory 220-2 assigned to the imaging device 14, a buffer-memory readout circuit (buffer-memory reading unit) 230, a synchronization detection circuit (hereinafter, “sync detect circuit”) (synchronization detector) 240, the single image processing circuit (image processor) 250, the image combining circuit 260, the bus I/F circuit 270, and the internal bus 280 that connects between the image processing circuit 250, the image combining circuit 260, and the bus I/F circuit 270 to one another. The bus I/F circuit 270 is connected to the bus 100 illustrated in FIG. 2.

Each of the imaging devices 13 and 14 outputs horizontal/vertical sync signals, pixel clocks, and the like in conjunction with image data. These signals are supplied to the buffer memory 210-2, 220-2 and the buffer-memory readout circuit 230. The horizontal/vertical sync signals are supplied also to the sync detect circuit 240.

Each of the buffer memories 210 and 220 sequentially stores image data output from corresponding one of the imaging devices 13 and 14 line by line. In this example, each of the buffer memories 210-2 and 220-2 assigned to one of the imaging devices 13 and 14 is configured to include line memories for four lines. In other words, each of the buffer memories 210-2 and 220-2 can store up to four lines of image data output from corresponding one of the imaging devices 13 and 14. Specifically, each of the buffer memories 210-2 and 220-2 sequentially stores image data output from corresponding one of the imaging devices 13 and 14 line by line in rotation in, for example, the following order: a line memory 1, a line memory 2, a line memory 3, a line memory 4, the line memory 1, . . . .

The buffer-memory readout circuit 230 reads out image data from the buffer memories 210-2 and 220-2 independently from image-data writing to the buffer memories 210-2 and 220-2. The buffer-memory readout circuit 230 has a read pointer that indicates from which line memories of the buffer memories 210-2 and 220-2 image data is to be read out next. Upon receiving a buffer-memory-readout-start command signal from the sync detect circuit 240, the buffer-memory readout circuit 230 reads out image data from the line memories indicated by the read pointer of the buffer memories 210 and 220 in a time division manner. The buffer-memory readout circuit 230 then updates the read pointer to enable image-data reading from the next line memories. Specifically, the read pointer is updated in the following order: 1, 2, 3, 4, 1, . . . . Accordingly, upon receiving the buffer-memory-readout-start command signal from the sync detect circuit 240, the buffer-memory readout circuit 230 reads out image data from the line memories 1, the line memories 2, the line memories 3, the line memories 4, the line memories 1, . . . of the buffer memories 210-2 and 220-2 in rotation. The sync detect circuit 240 will be described later.

The image processing circuit 250 receives inputs of the image data read out by the buffer-memory readout circuit 230 from the line memories of the buffer memories 210-2 and 220-2 and sequentially performs predetermined image processing on the image data in real time. The image processing circuit 250 also receives sync signals and the like supplied from the buffer-memory readout circuit 230. The image processing to be performed by the image processing circuit 250 is similar to that in the first embodiment and can include black level correction, color correction, correction of dropout pixels, and white balance adjustment.

The image data output from the imaging devices 13 and 14 and image-processed by the image processing circuit 250 is transferred to the DRAM 70 via the bus I/F circuit 270. The image data output from the imaging devices 13 and 14 and transferred to the DRAM 70 is separated into image data from the imaging device 13 and image data from the imaging device 14, and individually written into a storage area for the imaging device 13 in the DRAM 70 and that for the imaging device 14, respectively.

As described above, some image processing performed by the image processing circuit 250, such as lens distortion correction (correction of color aberration/distortion), cannot be performed on grouped image data into which image data from the imaging device 13 and image data from the imaging device 14 is grouped. Accordingly, also in the second embodiment, when processed image data output from the imaging device 13 or 14 and corresponding to one screen is stored in the DRAM 70, the CPU 40 reads out the image data output from the imaging device 13 or 14 and corresponding to one screen, and transfers the image data to the image processing circuit 250. The CPU 40 sequentially repeats this process. The image processing circuit 250 performs predetermined image processing, such as lens distortion correction, on the image data output from the imaging device 13 or 14 and corresponding to one screen, and writes the image data to the DRAM 70 again. The image processing circuit 250 sequentially repeats this process.

The image combining circuit 260 acquires the image data, on which the predetermined image processing is performed, from the imaging device 13 and the image data, on which the predetermined image processing is performed, from the imaging device 14 from the DRAM 70 via the bus I/F circuit 270, and combines the image data. Specifically, the DRAM 70 stores two hemispherical image data sets each of which is acquired by image capturing by one of the imaging devices 13 and 14 and on which the predetermined image processing is performed. The image combining circuit 260 generates spherical image data by combining the two hemispherical image data sets utilizing the overlap areas.

The spherical image data generated by the image combining circuit 260 is stored again in the DRAM 70 via the bus I/F circuit 270. Thereafter, the spherical image data is stored in an external memory via the external I/F circuit 90, or transferred to a personal computer or the like via the external I/F circuit 90 as required.

Also in the second embodiment, there can alternatively be employed the configuration in which the image combining circuit 260 generates a Mercator image as the spherical image data, and the CPU 40 converts the Mercator image into an omnidirectional panoramic image by geometric conversion.

The sync detect circuit 240 is described below. The sync detect circuit 240 is a circuit that monitors synchronization of output timing for outputting image data from the imaging devices 13 and 14. Each of the imaging devices 13 and 14 outputs horizontal/vertical sync signals, pixel clocks, and the like in conjunction with image data. The sync detect circuit 240 monitors horizontal/vertical sync signals output from the imaging devices 13 and 14 and issues the buffer-memory-readout-start command signal to the buffer-memory readout circuit 230 at an instant of completion of storing image data for a same line, which is output from the imaging devices 13 and 14, in the buffer memories 210-2 and 220-2.

In the example illustrated in FIG. 5, each of the buffer memories 210-2 and 220-2 assigned to one of the imaging devices 13 and 14 is configured to include line memories for four lines. With this configuration, out of synchronization of image data output from the imaging devices 13 and 14 is allowable by up to four lines. The sync detect circuit 240 determines whether sync signals output from the imaging devices 13 and 14 are in synchronization or not based on number of lines by which image data is out of synchronization. Specifically, conditionally on that output image data is out of synchronization by up to four lines, the sync detect circuit 240 issues the buffer-memory-readout-start command signal to the buffer-memory readout circuit 230 at an instant of completion of storing image data for a same line, which is output from the imaging devices 13 and 14, in the buffer memories 210-2 and 220-2.

Upon receiving the buffer-memory-readout-start command signal from the sync detect circuit 240, the buffer-memory readout circuit 230 starts reading out image data from the buffer memories 210-2 and 220-2. Specifically, in the example illustrated in FIG. 5, conditionally on that output image data is out of synchronization by four lines or less, the buffer-memory readout circuit 230 can read out image data for a same line in the time division manner by selecting line memories, in which the image data for the same line is stored, of the buffer memories 210-2 and 220-2 in rotation according to a fixed order. Accordingly, even when image data output from the imaging devices 13 and 14 is out of synchronization by a certain degree (specifically, up to four lines in the example illustrated in FIG. 5), it is possible to properly deliver the image data for the same line, which is output from the imaging devices 13 and 14, to the downstream image processing circuit 250.

On the other hand, if image data from the imaging devices 13 and 14 is out of synchronization by more than four lines, the sync detect circuit 240 sends a notification about occurrence of unallowable asynchronization to the CPU 40 (FIG. 2) via the bus I/F circuit 270. When the CPU 40 receives the notification about occurrence of unallowable asynchronization, the CPU 40 instructs the imaging control unit 30 (FIG. 2) to send a command for synchronization between output signals to the imaging devices 13 and 14. As a result, output signals from the imaging devices 13 and 14 are reset and synchronized to each other. In other words, the CPU 40 and the imaging control unit 30 function as a synchronization control unit that synchronizes output timing for outputting image data from the imaging devices 13 and 14.

Meanwhile, in the example illustrated in FIG. 5, each of the buffer memories 210-2 and 220-2 is configured to include line memories for four lines. However, the number of the line memories can be determined according to characteristics of the imaging devices (CMOS sensors or CCD sensors) and the like. Generally, it is desirable that each of the buffer memories 210-2 and 220-2 assigned to corresponding one of the imaging devices 13 and 14 includes line memories for n lines (n is an integer greater than one). Conditionally on that image data output from the imaging devices 13 and 14 is out of synchronization by n lines or less, the sync detect circuit 240 outputs the buffer-memory-readout-start command signal at an instant of completion of storing image data for a same line, which is output from the imaging devices 13 and 14, in the buffer memories 210-2 and 220-2. The sync detect circuit 240 outputs an out-of-sync signal when image data from the imaging devices 13 and 14 is out of synchronization by more than n lines.

Also in the second embodiment, write clock and read clock of the buffer memories 210-2 and 220-2 differ from each other in frequency in such a manner that the frequency of the read clock is m (m≧2) times as high as or higher than the frequency of the write clock. This setting allows the image processing circuit 250 to perform writing and reading to and from the buffer memories 210-2 and 220-2 line by line in real time without problem. When the frequency of the read clock is m times as high as the frequency of the write clock, image data is not overwritten before the image data is read out. It is possible to change the number of the line memories by changing the number of m.

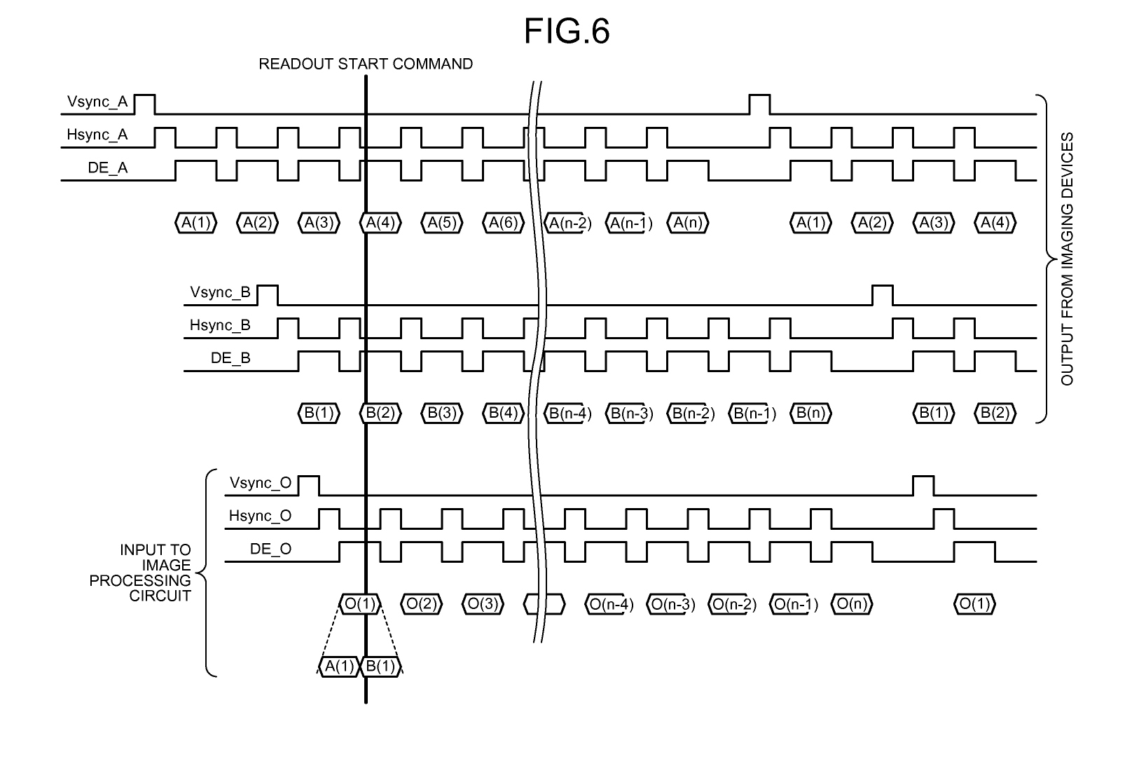

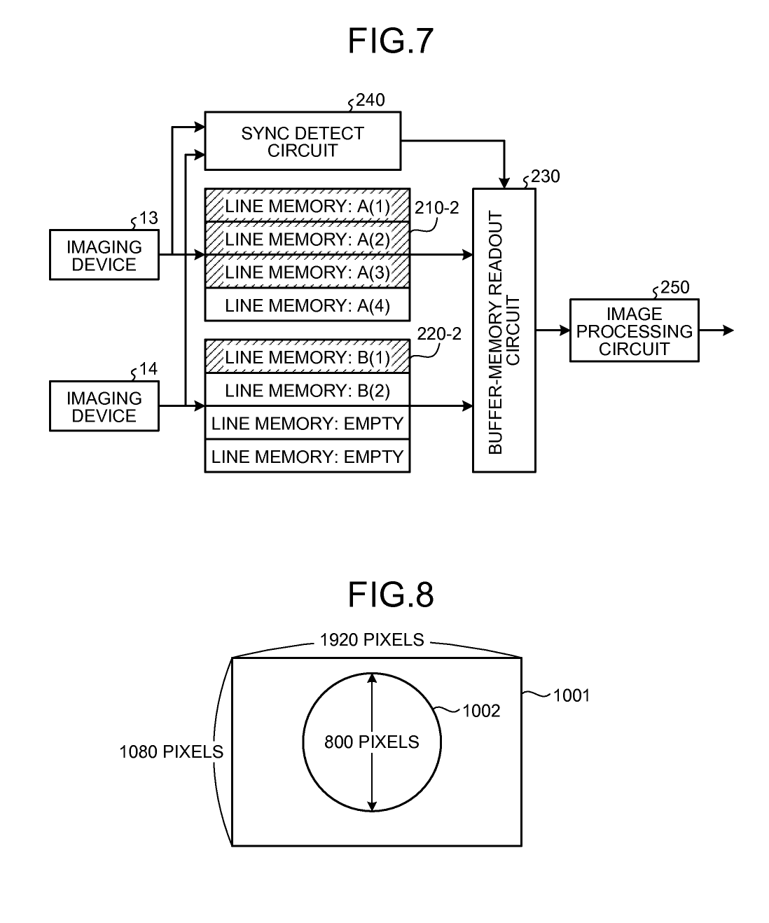

FIG. 6 is a diagram illustrating how image data is transferred in the second embodiment. FIG. 7 is a diagram illustrating how image data is stored in the buffer memories 210-2 and 220-2. Signals are plotted in FIG. 6 against time on the horizontal axis.

In FIG. 6, signals output from the imaging device 13 are indicated in the top zone, in which Vsync A denotes a vertical sync signal (output only once at a leading end of each page of a two-dimensional image); Hsync A denotes a horizontal sync signal (output at a leading end of each line); DE_A denotes a data enable signal; and each of A(1), A(2), A(3), . . . denotes image data for one line. Signals output from the imaging device 14 are indicated in the middle zone, in which Vsync_B denotes a vertical sync signal; Hsync_B denotes a horizontal sync signal; DE_B denotes a data enable signal; and each of B(1), B(2), B(3), . . . denotes image data for one line. The imaging devices 13 and 14 also output pixel clocks.

As indicated in the top and middle zones of FIG. 6, it is assumed that the image data output from the imaging devices 13 and 14 is out of synchronization by two lines.

Each of the image data output from the imaging devices 13 and 14 is sequentially stored in the line memories of corresponding one of the buffer memories 210-2 and 220-2 line by line. FIG. 7 illustrates how the image data is stored. Meanwhile, the sync detect circuit 240 monitors whether sync signals output from the imaging devices 13 and 14 are in synchronization or not. Specifically, the sync detect circuit 240 monitors synchronization of output timing for outputting image data from the imaging devices 13 and 14, and issues the buffer-memory-readout-start command signal to the buffer-memory readout circuit 230 at an instant of completion of storing image data for a same line, which is output from the imaging devices 13 and 14, in ones of the line memories of the buffer memories 210-2 and 220-2.

In the example illustrated in FIG. 7, the image data A(1), A(2), A(3), . . . from the imaging device 13 is sequentially stored in the line memories 1 to 3 of the buffer memory 210-2. At a point in time when the image data A(3) is stored in the line memory 3, the image data B(1) from the imaging device 14 is stored in the line memory 1 of the buffer memory 220-2. In other words, at this point in time, storing the image data for the first line, which is output from the imaging devices 13 and 14, in the buffer memories 210-2 and 220-2 is completed. Accordingly, the sync detect circuit 240 issues the buffer-memory-readout-start command signal to the buffer-memory readout circuit 230 at an instant when the image data B(1) from the imaging device 14 is stored in the line memory 1 of the buffer memory 220-2.

Upon receiving the buffer-memory-readout-start command signal from the sync detect circuit 240, the buffer-memory readout circuit 230 starts reading out image data from the buffer memories 210-2 and 220-2 in a time division manner. Specifically, the buffer-memory readout circuit 230 reads out the image data A(1) from the line memory 1 of the buffer memory 210-2 and sends the image data A(1) to the image processing circuit 250. Subsequently, the buffer-memory readout circuit 230 reads out the image data B(1) from the line memory 1 of the buffer memory 220-2 and sends the image data B(1) to the image processing circuit 250. The buffer-memory readout circuit 230 reads out the image data A(2) and B(2), A(3) and B(3), . . . in rotation from the buffer memories 210-2 and 220-2 in a similar manner and sends the image data to the image processing circuit 250. The buffer-memory readout circuit 230 also transmits sync signals and the like to the image processing circuit 250.

The image processing circuit 250 sequentially performs predetermined image processing on each group of the image data A(1) and B(1), A(2) and B(2), A(3) and B(3), . . . transmitted from the buffer-memory readout circuit 230 in real time and outputs the image data. This is illustrated in the bottom zone of FIG. 6. In FIG. 6, Vsync_O denotes a vertical sync signal for use by the image processing circuit 250; Hsync_O denotes a horizontal sync signal (output at a leading end of each line); and DE_O denotes a data enable signal. O(1) denotes a group of the image-processed output image data (A)1 and (B)1. Similarly, O(2), O(3), . . . denote groups of the image-processed output image data (A)2 and (B)2, A(3) and B(3), . . . .

As described above, in the second embodiment, each of the buffer memories 210-2 and 220-2 is made up of a plurality of line memories, and stores therein image data output from the imaging devices 13 and 14 line by line. The buffer-memory readout circuit 230 reads out the image data, which is from the imaging devices 13 and 14, from the buffer memories 210-2 and 220-2 in the time division manner and sends the image data to the single image processing circuit 250. Thereafter, the image processing circuit 250 performs predetermined image processing on each group of image data made up of the image data from the imaging device 13 and the image data from the imaging device 14. Thus, the need of having as many image processing circuits as the imaging devices is eliminated, and the amount of hardware of the image processing circuit can be reduced.

Furthermore, line memories for up to a few lines can satisfactorily be used as each of the buffer memories 210-2 and 220-2 by virtue of the relationship between the frequency of the read clock and the frequency of the write clock. Accordingly, an increase in cost can be reduced as compared with a configuration in which the number of image processing circuits increases as the number of imaging devices increases.

Furthermore, in the second embodiment, the sync detect circuit 240 issues the buffer-memory-readout-start command signal to the buffer-memory readout circuit 230 at an instant of completion of storing image data for a same line, which is output from the imaging devices 13 and 14, in the buffer memories 210-2 and 220-2. Accordingly, it is possible to send image data for a same line output from the imaging devices 13 and 14 properly to the downstream image processing circuit 250.

A method for outputting image data from the imaging device 13, 14 is described below.

In the omnidirectional image capturing apparatus illustrated in FIG. 1, the fisheye lens 11, 12 produces a circular fisheye image which is generally circular. In contrast, a data area (cell area) of the image sensor (CMOS sensor or the like) of the imaging device 13, 14 is generally rectangular (for example, 1920 pixels×1080 pixels). The circular fisheye images have image areas that overlap each other. This is because the fisheye images are to be stitched together in image processing to be performed later.

FIG. 8 is a diagram illustrating a relationship between an area of an image (circular fisheye image) on an image sensor produced by a fisheye lens and a data area (cell area) of the image sensor. In the example illustrated in FIG. 8, 1001 denotes an image-sensor data area (cell area) that is 1920 pixels×1080 pixels; 1002 denotes an area of an image to be produced by the fisheye lens (hereinafter, “fisheye-lens image area”) that is a circular area 800 pixels in diameter.

As illustrated in FIG. 8, the image-sensor data area 1001 contains a useless area (area where light through the fisheye lens does not fall) outside the fisheye-lens image (circular fisheye image) area 1002.

For this reason, in the first embodiment and the second embodiment, each of the imaging devices 13 and 14 regards a predetermined area that contains the fisheye-lens image area 1002 in the image-sensor data area 1001 as an active area, and outputs only data (i.e., image data) acquired in the active area but omits outputting data acquired in an inactive area which is an area outside the active area. Put another way, each of the imaging devices 13 and 14 skips reading data from the other area in the image-sensor data area 1001 than the predetermined area that contains the fisheye-lens image area 1002. As a result, time required to transfer image data from the imaging devices 13 and 14 to the image processing unit 20 (20-1, 20-2) can be reduced. Furthermore, it becomes possible to reduce storage capacity of each of the buffer memories (210-1, 220-1, 210-2, 220-2) of the image processing unit 20 (20-1, 20-2).

Each of the imaging devices 13 and 14 includes not only the image sensor for converting an optical image captured through the fisheye lens 11, 12 into image data represented by electrical signals but also the timing generating circuit for generating horizontal/vertical sync signals and pixel clocks for the image sensor, and the register set to be loaded with various types of commands, parameters, and the like necessary for operations of the imaging device. Setting of the predetermined area containing the fisheye-lens image area 1002 in the image-sensor data area 1001 is preferably made by utilizing some registers of the register set.

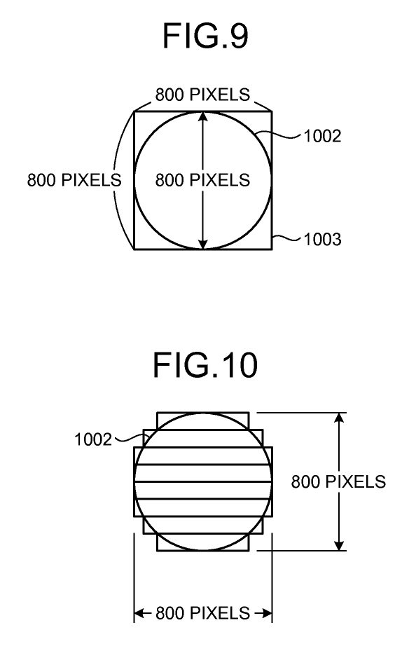

FIGS. 9 and 10 illustrate specific example methods for outputting image data from the image sensor in the imaging device 13, 14. Also in this example, the image sensor is assumed to have an image-sensor data area of 1920 pixels×1080 pixels and a fisheye-lens image (circular fisheye image) area that is a circular area 800 pixels in diameter.

FIG. 9 illustrates an example where data is output only from an active area 1003. The active area 1003 is a square area circumscribing the fisheye-lens image area 1002 (circular area 800 pixels in diameter) in the image-sensor data area 1001. In this example, data to be output is only data in the area of 800 pixels×800 pixels, which is a part of the whole data area of 1920 pixels×1080 pixels of the image sensor.

FIG. 10 illustrates an example where data is output from a horizontal data area whose width is increased or decreased every k lines (in the example illustrated in FIG. 10, every 100 lines) conforming to the fisheye-lens image area 1002 in a stepwise manner (circular area 800 pixels in diameter) in the image-sensor data area.

Specifically, data is output from the following data areas, each of which contains 100 lines, conforming to the shape of the fisheye-lens image area 1002 (circular area 800 pixels in diameter):

the 1st to the 100th lines: 600 pixels×100 pixels,

the 101st to the 200th lines: 700 pixels×100 pixels,

the 201st to the 300th lines: 780 pixels×100 pixels,

the 301st to the 400th lines: 800 pixels×100 pixels,

the 401st to the 500th lines: 800 pixels×100 pixels,

the 501st to the 600th lines: 780 pixels×100 pixels,

the 601st to the 700th lines: 600 pixels×100 pixels, and

the 701st to the 800th lines: 600 pixels×100 pixels.

Meanwhile, k is generally set to satisfy 1≦k≦the maximum number of lines.

An embodiment of the present invention has been described above, but the image capturing apparatus according to the present invention is not limited to the configurations illustrated in the drawings. As described above, the number of the lenses and that of the imaging devices can be three or more. The image capturing apparatus is not necessarily embodied as an omnidirectional image capturing apparatus. The lenses are not necessarily fisheye lenses.

According to the embodiments, it becomes unnecessary for an image capturing apparatus including a plurality of imaging devices to include as many image processors as the imaging devices. Accordingly, an increase in cost can be reduced. The image capturing apparatus includes a single image processor and is capable of handling image data from the plurality of imaging devices as image data from a single imaging device. Accordingly, complexity in data handling is resolved.

Furthermore, because the image capturing apparatus includes a synchronization detector, image data for a same line output from the plurality of imaging devices can be properly sent to the image processor. As a result, reliability is enhanced.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image capturing apparatus for capturing an image of a subject using a plurality of imaging devices and a plurality of lenses for the imaging devices, respectively, the image capturing apparatus comprising:
a plurality of buffer memories for the imaging devices, respectively, each buffer memory being configured to store image data output from the corresponding imaging device; and
a single image processor configured to read the image data stored in the buffer memories in a time division manner and perform predetermined image processing on the image data.

2. The image capturing apparatus according to claim 1, wherein each buffer memory is made of up line memories for up to two lines.

3. The image capturing apparatus according to claim 1, wherein a read clock for the buffer memories has a frequency m times as high as a frequency of a write clock for the buffer memories, where m is two or more.

4. The image capturing apparatus according to claim 1, wherein
each lens is a fisheye lens, and
each imaging device outputs image data of a predetermined area containing an image obtained by the fisheye lens.

5. The image capturing apparatus according to claim 4, wherein the predetermined area is a square area circumscribing the image obtained by the fisheye lens.

6. The image capturing apparatus according to claim 4, wherein each imaging device outputs pieces of image data of horizontal data areas each corresponding k lines, each horizontal data area having a different width such that the horizontal data areas conform to a shape of the image obtained by the fisheye lens in a stepwise manner, where k is in a range of 1 to a maximum number of lines.

7. An image capturing apparatus for capturing an image of a subject using a plurality of imaging devices and a plurality of lenses for the imaging devices, respectively, the image capturing apparatus comprising:
a plurality of buffer memories for the imaging devices, respectively, each buffer memory being configured to store image data output from the corresponding imaging device;
a synchronization detector configured to monitor synchronization of output timing for outputting image data from the imaging devices and control a timing of reading the image data from each buffer memory;
a buffer-memory reading unit configured to read the image data stored in the buffer memories in a time division manner in response to the timing of reading the image data; and
a single image processor configured to perform predetermined image processing on the image data read from the buffer memories in the time division manner.

8. The image capturing apparatus according to claim 7, wherein
each buffer memory includes line memories for n lines, where n is an integer greater than one, and
under a condition where the image data output from the imaging devices is out of synchronization by n lines or less, the synchronization detector sends, as the timing of reading the image data, a signal indicating a timing at which storing pieces of image data for a same line in the respective buffer memories is completed, to the buffer-memory reading unit.

9. The image capturing apparatus according to claim 8, wherein when the image data output from the imaging devices is out of synchronization by more than n lines, the synchronization detector outputs a signal indicating out-of-synchronization.

10. The image capturing apparatus according to claim 9, further comprising a synchronization control unit configured to synchronize timing for outputting image data from the imaging devices when the signal indicating out-of-synchronization is output from the synchronization detector.

11. The image capturing apparatus according to claim 7, wherein a read clock for the buffer memories has a frequency m times as high as a frequency of a write clock for the buffer memories, where m is two or more.

12. The image capturing apparatus according to claim 7, wherein
each lens is a fisheye lens, and
each imaging device outputs image data of a predetermined area containing an image obtained by the fisheye lens.

13. The image capturing apparatus according to claim 12, wherein the predetermined area is a square area circumscribing the image obtained by the fisheye lens.

14. The image capturing apparatus according to claim 12, wherein each imaging device outputs pieces of image data of horizontal data areas each corresponding k lines, each horizontal data area having a different width such that the horizontal data areas conform to a shape of the image obtained by the fisheye lens in a stepwise manner, where k is in a range of 1 to a maximum number of lines.
